(19) United States
(12) Patent Application Publication
(10) Pub. No.: US 2025/0278926 A1
(43) Pub. Date: Sep. 4, 2025

(54) METHOD AND APPARATUS RELATED TO DATA GENERATION FRAMEWORK

(71) Applicants: Hon Hai Precision Industry Co., Ltd., New Taipei City (TW); FOXCONN TECHNOLOGY GROUP CO., LTD, Shenzhen (CN)

(72) Inventors: Shen-Hsuan Liu, New Taipei City (TW); Chi-En Huang, New Taipei City (TW); Muhammad Saqlain Aslam, New Taipei City (TW); Yung-Hui Li, New Taipei City (TW); Sanhorn Chen, New Taipei City (TW)

(73) Assignees: Hon Hai Precision Industry Co., Ltd., New Taipei City (TW); FOXCONN TECHNOLOGY GROUP CO., LTD, Shenzhen (CN)

(21) Appl. No.: 19/069,248

(22) Filed: Mar. 4, 2025

Related U.S. Application Data
(60) Provisional application No. 63/560,790, filed on Mar. 4, 2024.

(51) Int. Cl. G06V 10/774; G06T 5/60; G06T 5/70; G06T 11/00; G06V 10/26; G06V 10/776; G06V 10/82

(52) U.S. Cl. CPC G06V 10/774; G06T 5/60; G06T 5/70; G06T 11/00; G06V 10/26; G06V 10/776; G06V 10/82; G06T 2207/20081; G06T 2207/20084

(57) ABSTRACT

A method and an apparatus related to a data generation framework are provided. A latent representation is obtained from training data by an initial encoder. The latent representation and first noise data are combined to generate a noisy latent representation. The noisy latent representation is input to a prediction model, and an initial prediction corresponding to the noisy latent representation is output by referring to first semantic mask data by the prediction model, wherein the first semantic mask data defines one or more first semantic categories for the training data. The prediction model is updated according to a prediction error between the initial prediction and the first noise data to generate a trained prediction model. Therefore, data that is close to the real world may be generated.

### CROSS-REFERENCE TO RELATED APPLICATION

This application claims the priority benefit of U.S. provisional application Ser. No. 63/560,790, filed on Mar. 4, 2024. The entirety of the above-mentioned patent application is hereby incorporated by reference herein and made a part of this specification.

### BACKGROUND

### Technical Field

The disclosure relates to a data generation technology, and in particular to a method and an apparatus related to a data generation framework.

### Description of Related Art

FIG. 1 is a schematic diagram of a simulation scenario. Please refer to FIG. 1. In the prior art, a simulator may generate corresponding images according to style conditions. For example, the style conditions are sunny day at noon, foggy day at noon, and rainy night. Alternatively, the simulator may generate corresponding images according to spatial conditions. For example, the spatial conditions are semantic mask and depth map that define corresponding categories of image regions. However, the conventional simulator can only generate fake images in a virtual scenario, which is even difficult to be used in an application involving a real scene, such as the application of autonomous driving scene understanding, element defect detection, etc. In addition, the design of three-dimensional objects is to design objects closer to the real world to reduce the difference between content generated by the simulator and the real world. However, designing diverse three-dimensional objects requires considerable costs and resources.

### SUMMARY

The disclosure provides a method and an apparatus related to a data generation framework, which may generate more realistic data.

A method related to a data generation framework according to an embodiment of the disclosure is implemented by a processor and includes the following steps of: obtaining a latent representation from training data by an initial encoder; combining the latent representation and first noise data to generate a noisy latent representation; inputting the noisy latent representation to a prediction model, and outputting an initial prediction corresponding to the noisy latent representation by referring to first semantic mask data by the prediction model, wherein the first semantic mask data defines at least one first semantic category for the training data; and updating the prediction model according to a prediction error between the initial prediction and the first noise data to generate a trained prediction model.

An apparatus related to a data generation framework according to an embodiment of the disclosure includes (but is not limited to) a storage and a processor. The storage is used to store a program code. The processor is coupled to the storage. The processor is configured to load the program code to execute: obtaining a latent representation from training data by an initial encoder; combining the latent representation and first noise data to generate a noisy latent representation; inputting the noisy latent representation to a prediction model, and outputting an initial prediction corresponding to the noisy latent representation by referring to first semantic mask data by the prediction model, wherein the first semantic mask data defines at least one first semantic category for the training data; and updating the prediction model according to a prediction error between the initial prediction and the first noise data to generate a trained prediction model.

Based on the above, the method and the apparatus related to the data generation framework according to the embodiments of the disclosure learn how to identify noise from input data, so as to subsequently remove the noise, thereby generating more realistic data. In this way, high quality, realistic, and reliable data generation may be provided.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a simulation scenario.

FIG. 2 is an element block diagram of an apparatus related to a data generation framework according to an embodiment of the disclosure.

FIG. 3 is a flowchart of spatial learning related to a data generation framework according to an embodiment of the disclosure.

FIG. 4 is a schematic diagram of spatial learning related to a data generation framework according to an embodiment of the disclosure.

FIG. 5 is a flowchart of spatial noise removal related to a data generation framework according to an embodiment of the disclosure.

FIG. 6 is a schematic diagram of spatial noise removal related to a data generation framework according to an embodiment of the disclosure.

FIG. 7 is a schematic diagram illustrating noise removal according to an embodiment of the disclosure.

FIG. 8 is a flowchart of multi-domain conditioned learning related to a data generation framework according to an embodiment of the disclosure.

FIG. 9 is a schematic diagram of multi-domain conditioned learning related to a data generation framework according to an embodiment of the disclosure.

FIG. 10 is a schematic diagram of a fusion layer according to an embodiment of the disclosure.

FIG. 11 is a schematic diagram of a generator according to an embodiment of the disclosure.

FIG. 12A is a schematic diagram of a style similarity error according to an embodiment of the disclosure.

FIG. 12B is a schematic diagram of a source preservation error according to an embodiment of the disclosure.

FIG. 12C is a schematic diagram of a content comparison error according to an embodiment of the disclosure.

FIG. 13 is a schematic diagram of a style option according to an embodiment of the disclosure.

FIG. 14 is a flowchart of inference of multi-domain conditions related to a data generation framework according to an embodiment of the disclosure.

FIG. 15 is a schematic diagram of inference of multi-domain conditions related to a data generation framework according to an embodiment of the disclosure.

FIG. 16A is a schematic diagram of scene image generation according to an embodiment of the disclosure.

FIG. 16B is a schematic diagram of facial image generation according to an embodiment of the disclosure.

FIG. 17A and FIG. 17B are experimental results of a spatial conditioned pipeline according to an embodiment of the disclosure.

FIG. 18 is an experimental result of a multi-domain conditioned pipeline according to an embodiment of the disclosure.

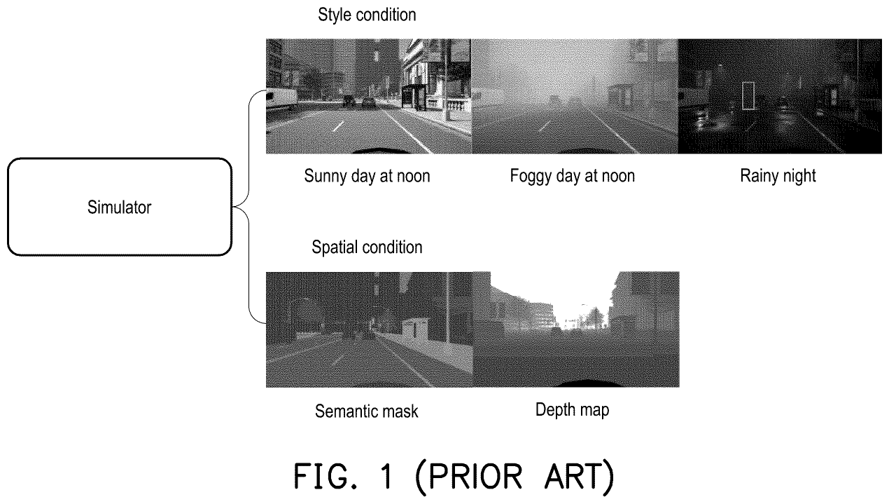

### DESCRIPTION OF THE EMBODIMENTS

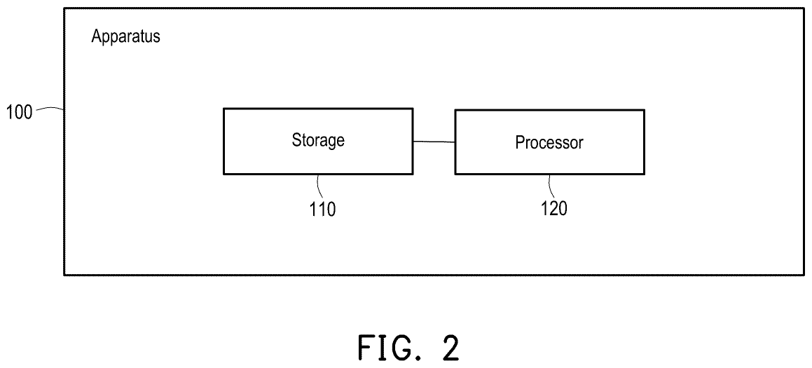

FIG. 2 is an element block diagram of an apparatus 100 related to a data generation framework according to an embodiment of the disclosure. Please refer to FIG. 2. The apparatus 100 includes (but is not limited to) a storage 110 and a processor 120. The apparatus 100 may be a mobile phone, a tablet computer, a notebook computer, a desktop computer, a server, a voice assistant apparatus, a smart home appliance, a wearable apparatus, a vehicle system, or other electronic apparatuses.

The storage 110 may be any type of fixed or removable random access memory (RAM), read only memory (ROM), flash memory, hard disk drive (HDD), solid state drive (SSD), or similar elements. In an embodiment, the storage 110 is used to store program codes, software modules, configurations, data (for example, model parameters, data sets, samples, features, or predictions), or files, which will be described in detail in subsequent embodiments.

The processor 120 is coupled to the storage 110. The processor 120 may be a central processing unit (CPU), a graphics processing unit (GPU), other programmable general-purpose or specific-purpose microprocessors, digital signal processors (DSP), programmable controllers, field programmable gate arrays (FPGA), application-specific integrated circuits (ASIC), neural processing units (NPU), tensor processing units (TPU), artificial intelligence (AI) accelerators, neural engines, other similar elements, or a combination of the above elements. In an embodiment, the processor 120 is used to execute all or some operations of the apparatus 100 and may load and execute various program codes, software modules, files, and data stored in the storage 110.

In the following, a method described in an embodiment of the disclosure will be illustrated with reference to various apparatuses, elements, and modules in the apparatus 100. Each procedure of the method may be adjusted according to the implementation situation and is not limited thereto.

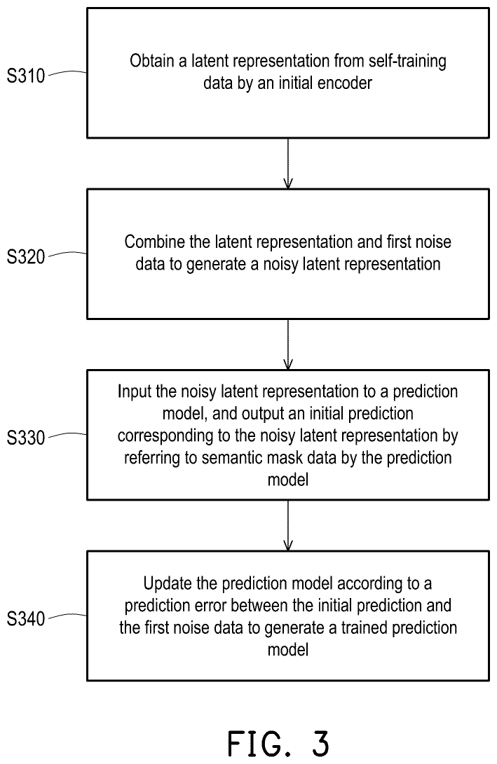

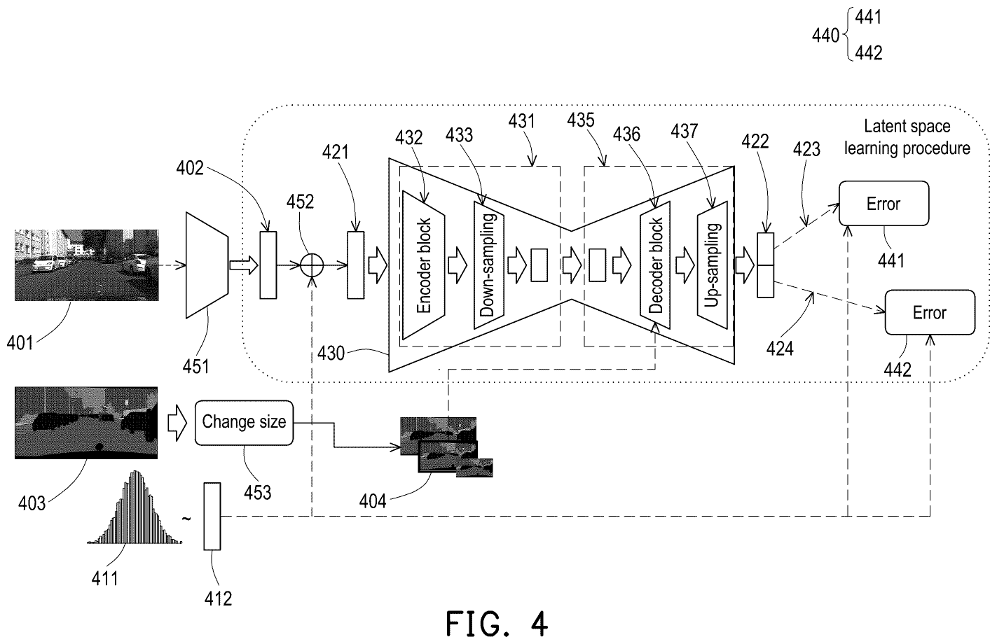

FIG. 3 is a flowchart of spatial learning related to a data generation framework according to an embodiment of the disclosure. Please refer to FIG. 3. The processor 120 obtains a latent representation from self-training data by an initial encoder (step S310). Specifically, the training data may be images, such as image samples obtained from (training) data sets from various sources. For example, FIG. 4 is a schematic diagram of spatial learning related to a data generation framework according to an embodiment of the disclosure. Please refer to FIG. 4. Training data 401 is an image of a street. In other embodiments, the training data may be sound, text, sensing intensity, angle, amplitude, position, or other forms of data.

In an embodiment, an initial encoder 451 is a vector quantized (VQ) encoder. The initial encoder 451 may divide a continuous high-dimensional vector space into several regions, and each region corresponds to one representative performance/representation (for example, a (compressed) vector, a code vector, or a codeword form). During an encoding process of the initial encoder 451, the processor 120 maps the input training data to a closest latent representation 402. The initial encoder 451 may map high-dimensional data to a low-dimensional space, while retaining important information of the data. Such low-dimensional performance/representation is often referred to as the latent representation 402.

In another embodiment, the initial encoder 451 is another encoder for dimensionality reduction or compression.

Please refer to FIG. 3. The processor 120 combines the latent representation and first noise data to generate a noisy latent representation (step S320). Specifically, the first noise data may be values based on a statistical distribution such as a Gaussian distribution, a uniform distribution, or a Poisson distribution or data generated based on noise in a real environment. It should be noted that to maximize the diversity of generated data, most techniques directly employ the Gaussian distribution, which has the maximum entropy. Other candidate distributions are not as effective in generating diversity, but they may be selected based on specific circumstances. Taking FIG. 4 as an example, the processor 120 samples a Gaussian distribution 411, and generates first noise data 412 according to sampled values. Next, the processor 120 adds the latent representation 402 and the first noise data 412, and uses the addition result as a noisy latent representation 421.

In an embodiment, the latent representation and the first noise data are in the vector form. The processor 120 may add the latent representation and the first noise data element-wise, and use the addition result as the noisy latent representation. For example, a first element of the latent representation is added to a first element of the first noise data to become a first element of the noisy latent representation, a second element of the latent representation is added to a second element of the first noise data to become a second element of the noisy latent representation, and the rest may be deduced by analogy and will not be repeated here.

Please refer to FIG. 3. The processor 120 inputs the noisy latent representation to a prediction model, and outputs an initial prediction corresponding to the noisy latent representation by referring to semantic mask data by the prediction model (step S330). Specifically, in a training phase, the noisy latent representation and a ground truth (for example, the first noise data) are used as training samples of the prediction model. The processor 120 may train the prediction model through a machine learning algorithm. The machine learning algorithm may analyze marked training samples (for example, the noisy latent representation with the corresponding ground truth) to establish a correlation between the latent representation embedded/added with noise (that is, the input of the model, such as the noisy latent representation 421 shown in FIG. 4) and the embedded/added noise (that is, the output of the model, such as an initial prediction 422 shown in FIG. 4). The first noise data 412 would be considered as the ground truth. The output of the model should be close to the ground truth. That is the model should be trained so that its output approximates the first noise data 412, such as Gaussian noise, hidden in the input (i.e., the noisy latent representation 421). The prediction model may be learned, and inference on data to be evaluated (for example, a latent representation to be evaluated or other data) may be made accordingly to output an initial prediction (for example, noise data in the latent representation or other data) corresponding to the data to be evaluated.

The type of the machine learning algorithm may change according to the application scenario. The machine learning algorithm may be semantic latent diffusion, latent diffusion, or stochastic diffusion, but not limited thereto.

A prediction model 430 of FIG. 4 takes a semantic latent diffusion network as an example. The prediction model 430 includes an encoder 431 and a decoder 435. The encoder 431 is connected to the decoder 435. For example, an output (for example, a feature map) of the encoder 431 is used as an input of the decoder 435. In an embodiment, for example, the encoder 431 and the decoder 435 have U-Net connection architectures.

The encoder 431 includes one or more encoder blocks 432. The encoder block 432 is, for example, a diffusion encoder residual block (DER). A semantic latent diffusion residual block is a core element of an encoder part of a semantic latent diffusion model, and the main function thereof is to perform feature encoding or feature retrieval on input data with noise (for example, the noisy latent representation 421). The encoder block 432 includes, for example, a convolutional layer, an activation function, a residual connection, and normalization processing, but not limited thereto.

In an embodiment, the encoder 431 includes multiple encoder blocks 432. The processor 120 may perform down-sampling 433 on the output of the encoder block 432 to obtain data with smaller size or lower resolution. That is, the down-sampling 433 is used to reduce size or resolution. The data with smaller size or lower resolution may be input to the next encoder block 432. In other words, the encoder blocks 432 respectively correspond to data with different sizes or resolutions.

The decoder 435 includes one or more decoder blocks 436. The decoder block 436 is, for example, a diffusion decoder residual block (DDR). The semantic latent diffusion residual block is the core element of the encoder part of the semantic latent diffusion model, and the main function thereof is to combine features (also referred to as a feature map) retrieved by the encoder 431 and semantic information or spatial information (for example, first semantic mask data 403 and 404, which will be introduced later). The decoder block 436 includes, for example, a deconvolutional layer, a convolutional layer, an activation function, a residual connection, and normalization processing, but not limited thereto.

In an embodiment, the decoder 435 includes multiple decoder blocks 436. The processor 120 may perform up-sampling 437 on the output of the decoder block 436 to obtain data with larger size or higher resolution. That is, the up-sampling 437 is used to increase size or resolution. The data with larger size or higher resolution may be input to the next decoder block 436 or used as the output (that is, the initial prediction 422) of the decoder 435 or the prediction model 430. In other words, the decoder blocks 436 respectively correspond to data with different sizes or resolutions.

The first semantic mask data 403 and 404 define one or more first semantic categories for the training data 401. The first semantic mask data 403 is marked data with the same size or resolution as the training data 401. The first semantic mask data 403 and 404 are composed of multiple blocks, elements, or pixels. Taking the image form as an example, each pixel in the first semantic mask data 403 and 404 is assigned a predefined (first) semantic category (also referred to as label or semantic information). Taking a scene application as an example, the semantic category may be a lane, a car, a pedestrian, a building, or the sky.

In an embodiment, the processor 120 may generate the first semantic mask data 403 through a direct corresponding generator. The generator may generate the first semantic mask data 403 randomly or based on rules. In another embodiment, the processor 120 may receive a user operation, and define one or more first semantic categories in the first semantic mask data 403 and the first semantic category corresponding to the blocks, the elements, or the pixels in the first semantic mask data 403 according to parameters corresponding to the user operation.

In an embodiment, the processor 120 may generate the first semantic mask data 404 with multiple sizes (or multiple resolutions) (that is, change a size 453 or the resolution of the first semantic mask data 403). The size or the resolution of the first semantic mask data 404 is smaller or lower than the size or the resolution of one or more first semantic mask data 403. The first semantic mask data 404 with a certain size is aligned to the size of feature data (for example, the up-sampled feature map of the output of the encoder 431 or the output of another decoder block 436) input to the corresponding decoder block 436, and the first semantic mask data 404 and the feature data with the same size are input to the decoder block 436. In an embodiment, in response to the decoder 435 including multiple decoder blocks 436, the first semantic mask data 404 with multiple sizes or resolutions are respectively input to the same or corresponding decoder block 436 to increase sensitivity of the prediction model 430 to the semantic information with multiple resolutions or sizes.

In an embodiment, the decoder 435 or the decoder block 436 may adaptively adjust the mean and the variation (corresponding to a variation range of the mean) of the input feature map according to the first semantic mask data 403.

In an embodiment, the initial prediction 422 includes a predicted mean 423 and a predicted variation 424 corresponding to the predicted mean 423. The initial prediction 422 or the predicted mean 423 is, for example, the noise data predicted by the prediction model 430 for the noisy latent representation 421 (for example, the noise data predicted to be added or embedded to the noisy latent representation 421 or predicted first noise data).

Please refer to FIG. 3. The processor 120 updates the prediction model according to a prediction error between the initial prediction and the first noise data to generate a trained prediction model (step S340). Specifically, one of multiple targets of the training phase is to minimize a loss function (related to an error/a loss between the output of the prediction model (that is, the initial prediction 422 of FIG. 4) and the ground truth (for example, the first noise data 412) in the training sample). In an embodiment, in the training phase of the prediction model, the parameters of the prediction model are recursively updated through minimizing the loss function, for example, by back-propagation. The parameters of the model are, for example, weights, number of layers, positions or number of neurons, activation functions, or offsets, but not limited thereto. The method of updating the parameters is, for example, through gradient descent, an adaptive moment estimation (Adam) optimizer, momentum, adaptive gradient (Adagrad), or a conjugate gradient method, but not limited thereto. In other words, one of the targets of the training phase is to make the initial prediction output by the prediction model close to or the same as the corresponding ground truth. In an embodiment, the trained prediction model means that the loss function has converged, the prediction accuracy has reached a corresponding threshold, or the training has reached a standard for stopping training early. However, the standard for training completion may still be adjusted according to other tasks or requirements.

Please refer to FIG. 4, the loss function is based on a prediction error 440 between the initial prediction 422 and the first noise data 412. In an embodiment, the prediction error 440 is related to a first error 441 and a second error 442, such as the sum of the first error 441 and the second error 442. The processor 120 may calculate a difference between the predicted mean 423 and the mean of the first noise data 412 to determine the first error 441 (for example, an L1 loss). The mean of the first noise data 412 is, for example, the mean of the Gaussian distribution 411. The first error 441 is, for example, a difference value between the predicted mean 423 and the mean of the Gaussian distribution 411. The processor 120 may calculate a difference between the predicted variation 424 and the variation of the first noise data 412 to determine the second error 442 (for example, Kullback-Leibler (KL) divergence). The variation of the first noise data 412 is, for example, the variation of the Gaussian distribution 411. The second error 442 is, for example, a difference value between the predicted variation 424 and the variation of the Gaussian distribution 411.

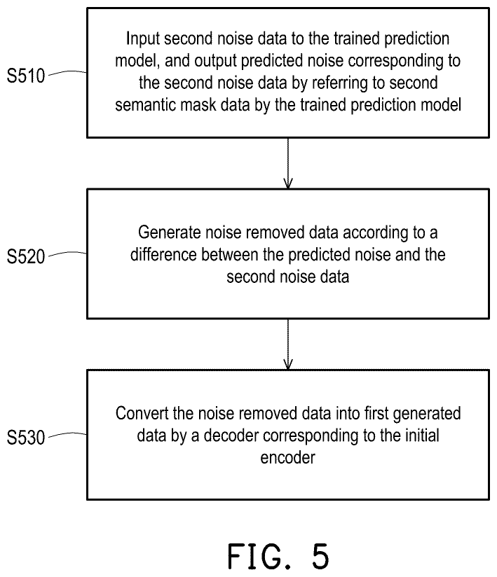

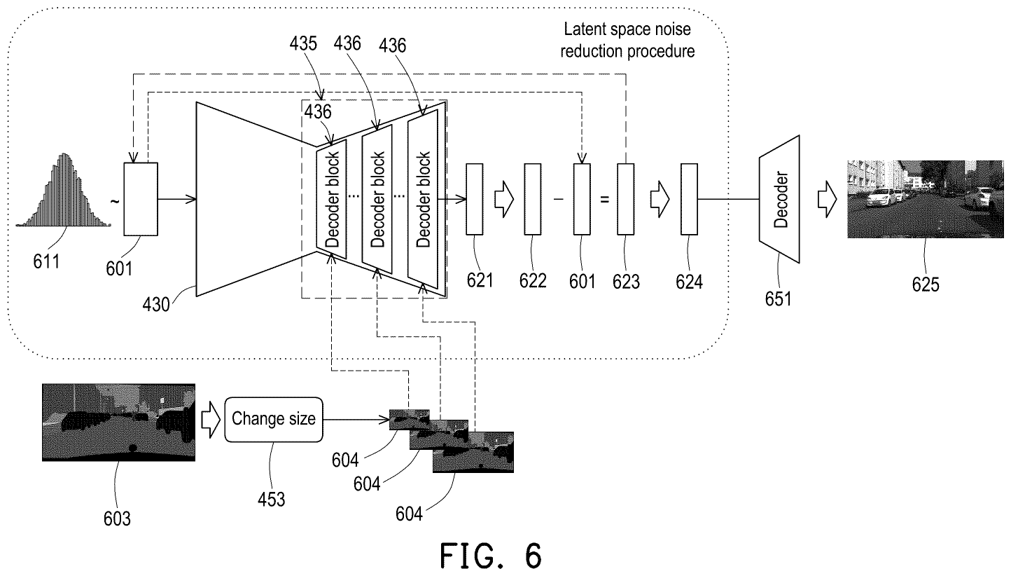

FIG. 5 is a flowchart of spatial noise removal related to a data generation framework according to an embodiment of the disclosure. Please refer to FIG. 5. The processor 120 inputs second noise data to the trained prediction model, and outputs predicted noise corresponding to the second noise data by referring to second semantic mask data by the trained prediction model (step S510). Specifically, the second noise data may be values based on a statistical distribution such as a Gaussian distribution, a uniform distribution, or a Poisson distribution or data generated based on noise in a real environment. It should be noted that to maximize the diversity of generated data, most techniques directly employ the Gaussian distribution, which has the maximum entropy. Other candidate distributions are not as effective in generating diversity, but they may be selected based on specific circumstances. FIG. 6 is a schematic diagram of spatial noise removal related to a data generation framework according to an embodiment of the disclosure. Taking FIG. 6 as an example, the processor 120 samples a Gaussian distribution 611, and generates second noise data 601 according to sampled values. Next, the processor 120 uses the second noise data 601 as the input of the trained prediction model 430. That is, the second noise data 601 is input to the trained prediction model 430.

The second semantic mask data 603 defines one or more second semantic categories for first generated data 625. The second semantic mask data 603 is marked data with the same size or resolution as the first generated data 625. Second semantic mask data 603 and 604 are composed of multiple blocks, elements, or pixels. Taking the image form as an example, each pixel in the second semantic mask data 603 and 604 is assigned a predefined (second) semantic category (also referred to as label or semantic information). Taking the scene application as an example, the semantic category may be a lane, a car, a pedestrian, a building, or the sky. Taking a face application as an example, the semantic category may be black skin, a nose, double eyelids, or curly hair. The first generated data 625 is data expected to be generated. The first generated data 625 may be in the image form. In other embodiments, the first generated data 625 may be sound, text, sensing intensity, angle, amplitude, position, or other forms of data.

In an embodiment, the processor 120 may generate the second semantic mask data 603 through a direct corresponding generator. The generator may generate the second semantic mask data 603 randomly or based on rules. In another embodiment, the processor 120 may receive a user operation, and define one or more second semantic categories in the second semantic mask data 603 and the second semantic category corresponding to the blocks, the elements, or the pixels in the second semantic mask data 603 according to parameters corresponding to the user operation.

In an embodiment, the processor 120 may generate the second semantic mask data 604 with multiple sizes (or multiple resolutions) (that is, change the size 453 or the resolution of the second semantic mask data 603). The size or the resolution of the second semantic mask data 604 is smaller or lower than the size or the resolution of one or more second semantic mask data 603. The second semantic mask data 604 with a certain size is aligned to the size of the feature data (for example, the up-sampled feature map of the output of the encoder 431 or the output of another decoder block 436) input to the corresponding decoder block 436, and the second semantic mask data 604 and the feature data with the same size are input to the decoder block 436. In an embodiment, in response to the decoder 435 including multiple decoder blocks 436, the second semantic mask data 604 with multiple sizes or resolutions are respectively input to the same or corresponding decoder block 436 to increase the sensitivity of the prediction model 430 to the semantic information with multiple resolutions or sizes.

The decoder 435 or the trained prediction model 430 outputs predicted noise 621 corresponding to the second noise data 601. The predicted noise 621 includes a mean and a variation corresponding to the mean. The processor 120 may generate predicted noise 622 based on the predicted noise 621. For example, the predicted noise 622 is n+(e^{0.5v}*0.5), where n is the mean of the predicted noise 621 and v is the variation of the predicted noise 621.

Please refer to FIG. 5. The processor 120 generates noise removed data according to a difference between the predicted noise and the second noise data (step S520). Assuming that data is in the vector form, and the noise removed data is a vector of subtracting the predicted noise from the second noise data. Taking FIG. 6 as an example, the processor 120 subtracts the predicted noise 622 from the second noise data 601, and generates noise removed data 623.

In an embodiment, the processor 120 may input the noise removed data 623 to the trained prediction model 430, and output the predicted noise corresponding to the noise removed data by referring to the second semantic mask data 604 by the trained prediction model 430. That is, the processor 120 uses the noise removed data 623 as the input of the trained prediction model 430 or replaces the second noise data of step S510 with the noise removed data 623. Next, the processor 120 performs step S520. The processor 120 may repeat the above steps (that is, input the noise removed data 623 to the trained prediction model 430, output the predicted noise corresponding to the noise removed data by referring to the second semantic mask data 604 by the trained prediction model 430, and generate another noise removed data 623 according to a difference between the predicted noise 622 and the second noise data 601) until a stop condition is met. For example, the stop condition is to repeat the above steps 1000 times, but not limited thereto. Noise removed data 624 is noise removed data generated when the stop condition is met.

Please refer to FIG. 5. The processor 120 converts the noise removed data into first generated data by a decoder corresponding to the initial encoder of step S310 (S530). In an embodiment, the decoder corresponding to the initial encoder is a vector quantized (VQ) decoder. Taking FIG. 6 as an example, a decoder 651 may convert a discrete latent performance/representation (for example, a (compressed) vector, a code vector, or a codeword form) generated by a vector quantized encoder back into an original data space to implement reconstruction or generation of data. During a decoding process of the decoder 651, the processor 120 takes the retrieved (compressed) vector, code vector, or codeword as input to be converted back into the original data space through a series of operations (for example, deconvolution, convolution, etc.), to reconstruct the data. For example, the noise removed data 624 is converted into the first generated data 625. The decoder 651 may map low-dimensional data to a high-dimensional space, and perform feature conversion.

In another embodiment, the decoder 651 is another decoder for dimensionality enhancement or decompression.

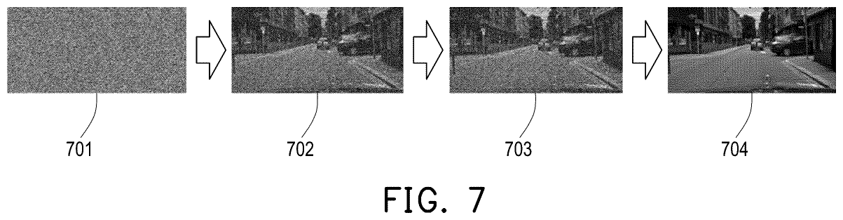

FIG. 7 is a schematic diagram illustrating noise removal according to an embodiment of the disclosure. Please refer to FIG. 7. First generated data 701, 702, 703, and 704 are respectively generated data converted through the decoder 651 from the noise removed data 624 generated by repeating the steps (for example, input the noise removed data 623 to the trained prediction model 430, output the predicted noise 622 corresponding to the noise removed data 623 by referring to the second semantic mask data 604 by the trained prediction model 430, and generate another noise removed data 623 according to the difference between the predicted noise 622 and the second noise data 601 of FIG. 6). As the number of repetitions increases (for example, the number of repetitions corresponding to the first generated data 704 is greater than that of the first generated data 703, the number of repetitions corresponding to the first generated data 703 is greater than that of the first generated data 702, and the number of repetitions corresponding to the first generated data 702 is greater than that of the first generated data 701), the image quality gradually improves. In some application scenarios, through repeated noise removal, the quality of data may be effectively improved to be closer to the real situation. For example, the first generated data 704 is a realistic street picture.

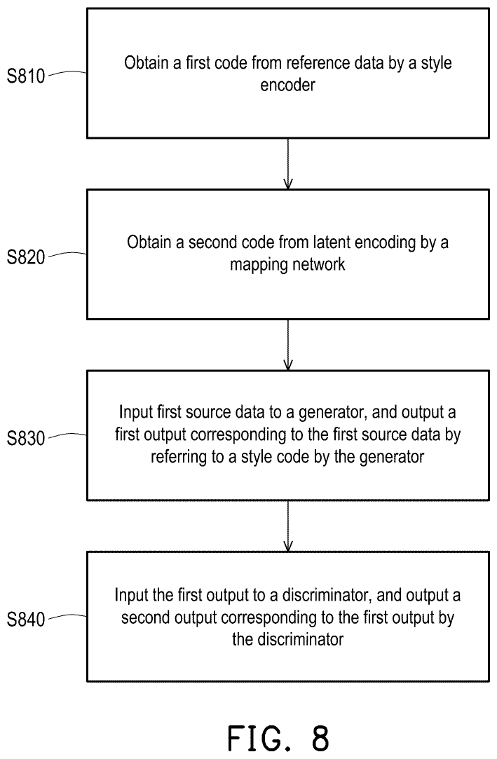

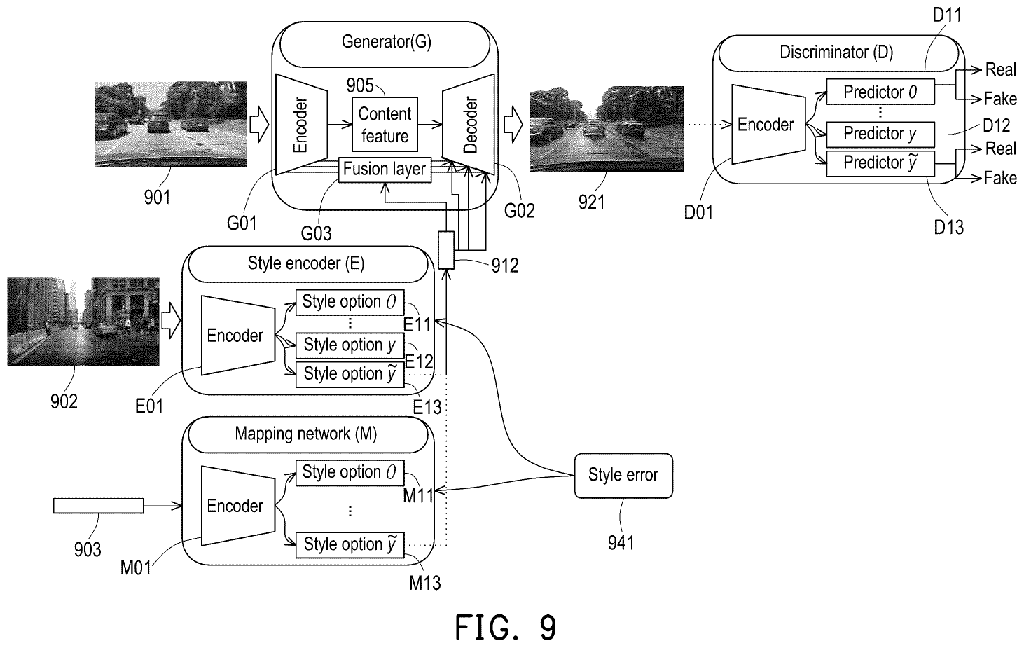

FIG. 8 is a flowchart of multi-domain conditioned learning related to a data generation framework according to an embodiment of the disclosure. Please refer to FIG. 8. The processor 120 obtains a first code from reference data by a style encoder (step S810). Specifically, FIG. 9 is a schematic diagram of multi-domain conditioned learning related to a data generation framework according to an embodiment of the disclosure. Please refer to FIG. 9. The processor 120 may obtain a training pair (including first source data 901 and reference data 902) from the storage 110. The first source data 901 and the reference data 902 may come from different data sets. For example, taking scene generation as an example, the first source data 901 is a street picture of a sunny day, and the reference data 902 is a street picture of a rainy day. However, contents of the first source data 901 and the reference data 902 may still be changed according to actual requirements. The first source data 901 and the reference data 902 may be in the image form. In other embodiments, the first source data 901 and the reference data 902 may be sounds, texts, sensing intensities, angles, amplitudes, positions, or data in other forms.

A style encoder E includes an encoder E01. The encoder E01 may be a shared encoder for multi-task learning. Multiple tasks share the same encoder E01, and representations/performances learned by the encoder E01 may capture common features between the tasks. The tasks correspond to, for example, different style options E11, E12, and E13. For example, the style option E11 numbered 0 is a sunny day. The tyle option E12 numbered y (y is a positive integer greater than 0) is a rainy day. The style option E13 numbered y is one of the style option E11 numbered 0 to the style option E12 numbered y. For example, a rainy day is selected as the style option E13 numbered y. The first code is a style code 912 corresponding to the style option E13. That is, the encoder E01 retrieves a feature performance/representation (for example, a vector or a matrix form) generated for the style option E13 from the reference data 902.

In an embodiment, the style encoder E also corresponds to a classifier or a decoder of a task, and the classifier or the decoder is used to convert the output of the encoder E01 into a prediction result of the corresponding task. For example, a classifier numbered 0 evaluates a generation effect of the sunny day corresponding to the style option E11 converted from the output of the encoder E01. That is, a generation result corresponding to the style option is scored.

Please refer to FIG. 8. The processor 120 obtains a second code from latent encoding by a mapping network (step S820). Specifically, please refer to FIG. 9. A mapping network M includes an encoder M01. The encoder M01 may be a shared encoder for multi-task learning. Multiple tasks share the same encoder M01, and representations/performances learned by the encoder M01 may capture common features between the tasks. The tasks correspond to, for example, different style options M11 and M13. For example, the style option M11 numbered 0 is daytime. The style option M13 numbered y is one of the style option M11 numbered 0 to style options with other numbers. For example, the daytime is selected as the style option M13 numbered y. The second code is a style code 912 corresponding to the style option M13. That is, the encoder M01 retrieves a feature performance/representation (for example, a vector or a matrix form) generated for the style option M13 from latent encoding 903.

In an embodiment, the mapping network M also corresponds to a classifier or a decoder of a task, and the classifier or the decoder is used to convert the output of the encoder M01 into a prediction result of the corresponding task. For example, the classifier numbered 0 converts the output of the encoder M01 into an evaluation of a generation effect of the daytime corresponding to the style option M11. That is, a generation result corresponding to the style option is scored.

In an implementation, the latent encoding 903 is noise data and may be a value based on a statistical distribution such as a Gaussian distribution, a uniform distribution, or a Poisson distribution or data generated based on noise in a real environment. For example, the processor 120 samples the Gaussian distribution, and generates the latent encoding 903 according to sampled values.

The first code and the second code are both the style codes 912. The second code is output from the same branch as the style encoder E, that is, respectively fed/input to subsequent modules. In additional, the style code 912 corresponds to one or more style options, such as the style options E13 and M13.

It should be noted that the contents and the types of the style options may still be changed according to actual requirements and are not limited by the embodiments of the disclosure.

Please refer to FIG. 8. The processor 120 inputs first source data to a generator, and outputs a first output corresponding to the first source data by referring to a style code by the generator (step S830). Specifically, the first source data is as described above for the first source data of FIG. 9 and will not be repeated here. The generator is a key element in a generative adversarial network (GAN). The generator may generate new data samples (for example, images, text, music, etc.) from a latent space or random noise. In some application scenarios, the generator is used to learn the distribution of real data, and generate the new samples similar to the real data.

Please refer to FIG. 9. A generator G includes an encoder G01 and a decoder G02. The encoder G01 is connected to the decoder G02. For example, the output (for example, a content feature 905/feature map) of the encoder G01 is used as the input of the decoder G02. The encoder G01 may encode input data (for example, the first source data 901) into a latent vector (for example, the content feature 905 or a latent feature), and retrieve important information and variation factors in the input data accordingly. The decoder G02 converts the latent vector into a high-dimensional data representation, and converts the data representation into an output (for example, a first output 921) in the same format as the real data.

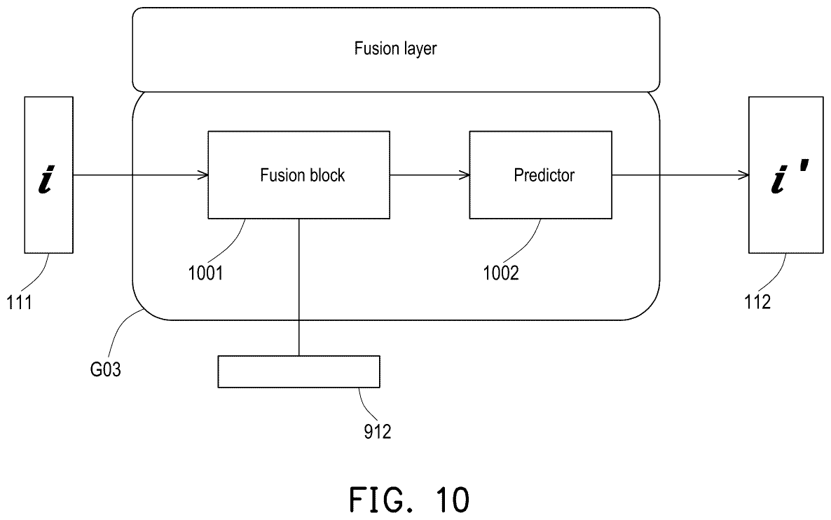

In an embodiment, the generator G further includes a fusion layer G03. The fusion layer G03 is connected between the encoder G01 and the decoder G02. FIG. 10 is a schematic diagram of the fusion layer G03 according to an embodiment of the disclosure. Please refer to FIG. 10. The fusion layer G03 includes a fusion block 1001 and a predictor 1002. The fusion block 1001 fuses an output from a certain encoder block (to be introduced in subsequent embodiments) of the encoder G01 (for example, feature data 111 or other feature representations/expressions, and the fusion block 1001 of the encoder block is connected through a residual connection) and the style code 912 from the style encoder E and/or the mapping network M to generate fusion data, and enhance style information in the output of the certain decoder block of the encoder G01 accordingly. The predictor 1002 is connected to the fusion block 1001. The predictor 1002 may convert the fusion data output by the fusion block 1001 into the style option corresponding to the style code 912. The output of the fusion layer G03 may be used as an input 112 of the certain decoder block (to be introduced in subsequent embodiments) of the decoder G02. That is, the processing of the reference style code 912 is implemented through the fusion processing of the fusion layer G03.

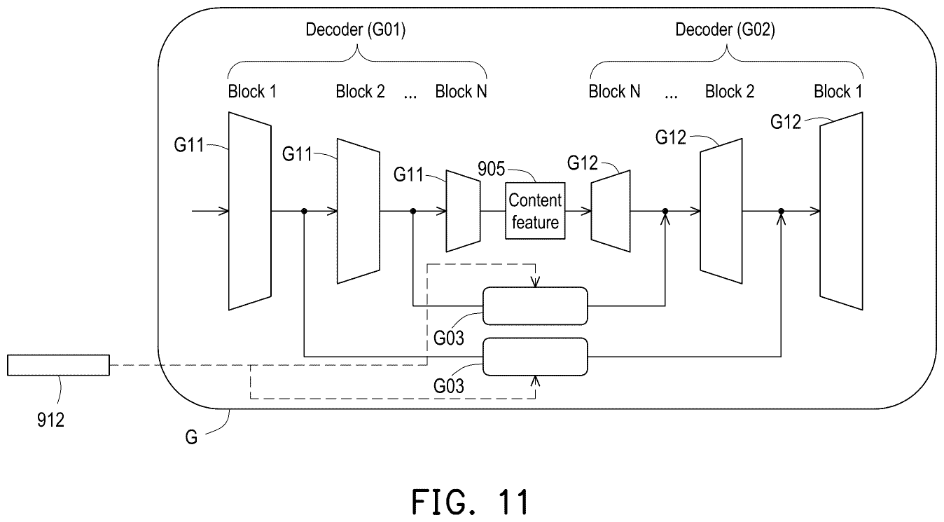

FIG. 11 is a schematic diagram of the generator G according to an embodiment of the disclosure. Please refer to FIG. 11. The encoder G01 includes one or more encoder blocks G11 (for example, a block numbered 1, a block numbered 2 to a block numbered N, where N is a positive integer). The encoder block G11 includes, for example, a convolutional layer, down-sampling processing, and residual connection processing, but not limited thereto. The decoder G02 includes one or more decoder blocks G12 (for example, a block numbered 1, a block numbered 2 to a block numbered N, where N is a positive integer). The decoder block G12 includes, for example, a deconvolutional layer, a fully connected layer, up-sampling processing, and excitation function processing, but not limited thereto. The fusion layer G03 may be inserted into a U-net similar network. For example, the encoder G01 shown in the drawing is composed of the encoder G01 and the decoder G02, the encoder G01 may down-sample the dimension of the latent space, and the decoder G02 may up-sample the dimension of the latent space. The generator G may include one or more fusion layers G03. The input of each fusion layer G03 is the same as or corresponds to the size or the resolution of the output. The processor 120 may input the fusion data and another feature data to the decoder block G12, and the another feature data is the output (for example, the content feature 905) of the encoder block G11 located adjacent to the front (for example, adjacent to the left in the drawing) or the output of another decoder block G12 located adjacent to the front (for example, adjacent to the left in the drawing).

In addition, the user may insert one or more fusion layers G03 between the encoder block G11 and the decoder block G12 corresponding to a specific size or dimension according to actual requirements, which are not limited by the embodiments of the disclosure.

Since the decoder G02 also inputs the output of the fusion layer G03 (the style information entrained with the style code 912), the output (for example, the first output 921 of FIG. 9) of the decoder G02 may be regarded as style translation data. Taking FIG. 9 as an example, the first source data 901 is in an image format, and the first output 921 is a style translation image. In addition, the first output 921 has the style option (taking the rainy day as an example) corresponding to the style code 912, but the same lane, vehicle, and scenery in the first source data 901 are still retained.

Please refer to FIG. 8. The processor 120 inputs the first output to a discriminator, and outputs a second output corresponding to the first output by the discriminator (step S840). Specifically, the discriminator is another key element in the generative adversarial network (GAN). The generator may distinguish between real data (for example, images, text, music, etc.) and the first output that is output by the generator G, that is, judge whether the input data (for example, the first output of the generator) is true (real) or false (fake). In an embodiment of the disclosure, the second output that is output by the discriminator includes real or fake corresponding to the style option, that is, judge whether the first output corresponds to the style option. “Real” means corresponding to or the same as the style option, and “fake” means not corresponding to or different from the style option. The discriminator includes, for example, a convolutional layer, a fully connected layer, an activation function, and a normalization layer, but not limited thereto.

Taking FIG. 9 as an example, a discriminator D includes an encoder D01. The encoder D01 may be a shared encoder for multi-task learning. Multiple tasks share the same encoder D01, and representations/performances learned by the encoder D01 may capture common features between the tasks. The tasks correspond to, for example, different style options. For example, the style option numbered 0 is the sunny day. The style option numbered y (y is a positive integer greater than 0) is the rainy day. The style option numbered y is one of the style option numbered 0 to the style option numbered y. For example, the rainy day is selected as the style option numbered y. The encoder D01 may retrieve a feature performance/representation (for example, a vector or a matrix form) generated for a specific style option from the first output 921.

The discriminator D includes a predictor D11 numbered 0 to a predictor D12 numbered y (y is a positive integer). A predictor D13 numbered y is one of the predictor D11 numbered 0 to the predictor D12 numbered y. Each numbered predictor is used to judge whether a specific style option is corresponded to. For example, the predictor D11 numbered 0 judges whether there is the style option of the sunny day. “Real” means corresponding to or the same as the style of the sunny day, and “fake” means not corresponding to or different from the style of the sunny day.

In an embodiment, the style options corresponding to the predictors D11 to D13 of the discriminator D may correspond to the style options of the style encoder E and the mapping network M. In other embodiments, contents of the style options may still be changed according to actual requirements.

In an embodiment, please refer to FIG. 9. The processor 120 may update at least one of the style encoder E, the mapping network M, the generator G, and the discriminator D according to a style error 941. One of the targets of the training phase is to minimize the loss function (related to the error/loss between the output of the style encoder E, the mapping network M, the generator G, and/or the discriminator D and the corresponding data). In an embodiment, in the training phase of the prediction model, the parameters of the prediction model are recursively updated through minimizing the loss function, for example, by back-propagation. The parameters of the model are, for example, weights, number of layers, positions or number of neurons, activation functions, or offsets, but not limited thereto. The method of updating the parameters is, for example, through gradient descent, an adaptive moment estimation optimizer, momentum, adaptive gradient, or a conjugate gradient method, but not limited thereto. In other words, one of the targets of the training phase is to make it difficult for the discriminator D to identify whether the output of the generator G is “real” or “fake”. In an embodiment, the trained prediction model means that the loss function has converged, the prediction accuracy has reached the corresponding threshold, or the training has reached the standard for stopping training early. However, the standard for training completion may still be adjusted according to other tasks or requirements.

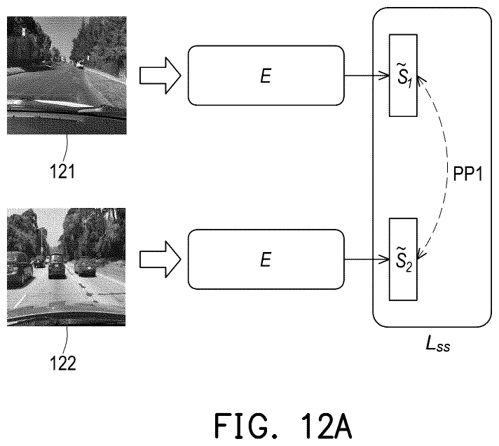

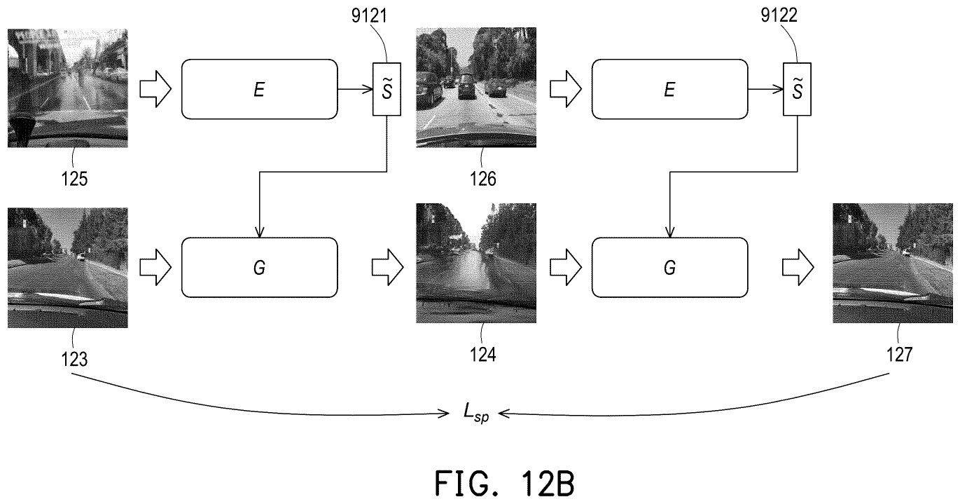

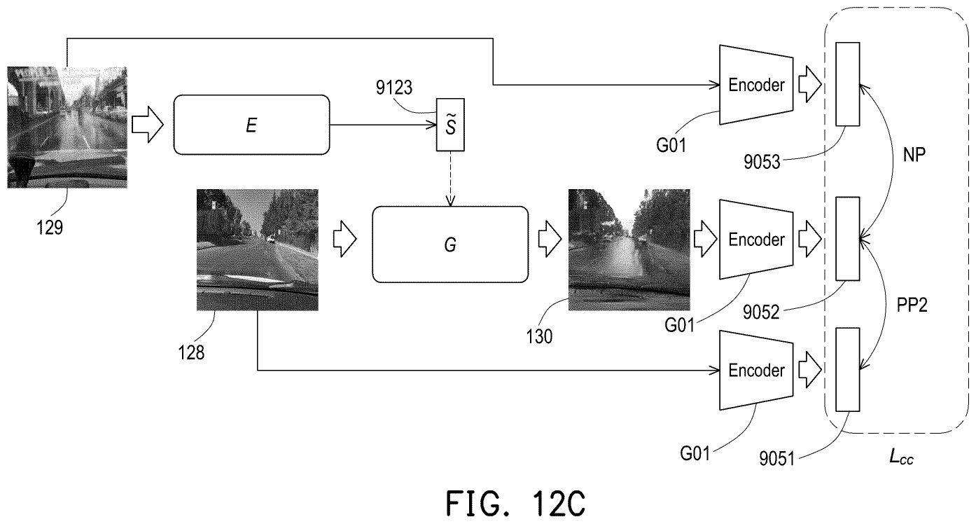

FIG. 12A is a schematic diagram of a style similarity error L_{SS} according to an embodiment of the disclosure. Please refer to FIG. 12A. The style error 941 of FIG. 9 includes the style similarity error L_{SS}. The processor 120 may calculate a difference between first codes \tilde{s}₁ and \tilde{s}₂ (forming a positive pair PP1) respectively obtained from first source data 121 (for example, the first source data 901 of FIG. 9) and second source data 122 by the style encoder E to determine the style similarity error L_{SS}. The second source data 122 and the first source data 121 correspond to the same style option, such as the sunny day. In addition, the style similarity error L_{SS} is, for example, a difference value obtained by subtracting the first code \tilde{s}₂ from the first code \tilde{s}₁ in the vector form. In other words, one of the targets of the loss function is that the style codes generated by the style encoder E for multiple data of the same style option are the same or similar.

FIG. 12B is a schematic diagram of a source preservation error L_{SP} according to an embodiment of the disclosure. Please refer to FIG. 12B. The style error 941 of FIG. 9 includes the source preservation error L_{SP}. The processor 120 may calculate a difference between first source data 123 (for example, the first source data 901 of FIG. 9) and second generated data 127 to determine the source preservation error L_{SP}. The generator G refers to a style code 9121 and outputs third generated data 124 corresponding to the first source data 123. The style code 9121 is a first code \tilde{s} obtained from reference data 125 (for example, the reference data 902 of FIG. 9) by the style encoder E. The generator G refers to a second style code 9122 and outputs the second generated data 127 corresponding to the third generated data 124. The second style code 9122 is obtained from second reference data 126 by the style encoder E, and the second reference data 126 and the first source data 123 correspond to the same style option (for example, the sunny day). The reference data 125 and the first source data 123 may correspond to the same or different style options. In addition, the source preservation error L_{SP} is, for example, a difference value obtained by subtracting the second generated data 127 from the first source data 123 in the matrix form. In other words, one of the targets of the loss function is that the second generated data 124 generated by the generator G may be restored to the first source data 123 or similar to the first source data 123 by referring to the style code of the same style option as the first source data 123 through the generator G.

FIG. 12C is a schematic diagram of a content comparison error L_{CC} according to an embodiment of the disclosure. Please refer to FIG. 12C. The style error 941 of FIG. 9 includes the content comparison error L_{CC}. The processor 120 may calculate a difference between a first feature representation 9051 and a second feature representation 9052 (forming a positive pair PP2), and calculate a difference between the second feature representation 9052 and a third feature representation 9053 (forming a negative pair NP2)) to determine the content comparison error L_{CC}. The first feature representation 9051 is obtained from first source data 128 (for example, the first source data 901 of FIG. 9) by the encoder G01 of the generator G. The generator G refers to a style code 9123 and outputs third generated data 130 corresponding to the first source data 128. The style code 9123 is the first code \tilde{s} obtained from reference data 129 (for example, the reference data 902 of FIG. 9) by the style encoder E. The second feature representation 9052 is obtained from the third generated data 130 by the encoder G01. In addition, the third feature representation 9053 is obtained from reference data 129 by encoder G01. The content comparison error L_{CC} uses, for example, the difference (for example, a difference value) between the second feature representation 9052 and the third feature representation 9053 as the denominator and the difference (for example, a difference value) between the first feature representation 9051 and the second feature representation 9052 as the numerator. Since one of the targets of the loss function is to minimize the output value, the larger the difference (considered as content similarity) between the second feature representation 9052 and the third feature representation 9053 the better and/or the smaller the difference (considered as content similarity) between the first feature representation 9051 and the second feature representation 9052 the better. Since the encoder G01 is used to retrieve the content feature, the more similar or the closer the first source data 128 and the content feature of the third generated data 130 generated by the generator G the better, but the less similar or the less close the reference data 129 and the content feature of the third generated data 130 the better.

In an embodiment, the style error 941 of FIG. 9 may be a sum of the style similarity error L_{SS} of FIG. 12A, the source preservation error L_{SP} of FIG. 12B, and the content comparison error L_{CC} of FIG. 12C. In another embodiment, depending on different design requirements, the style error 941 may also be a result of weighted operations of the style similarity error L_{SS}, the source preservation error L_{SP}, and the content comparison error L_{CC}. That is, corresponding weights or priorities are respectively given to the style similarity error L_{SS}, the source preservation error L_{SP}, and the content comparison error L_{CC}.

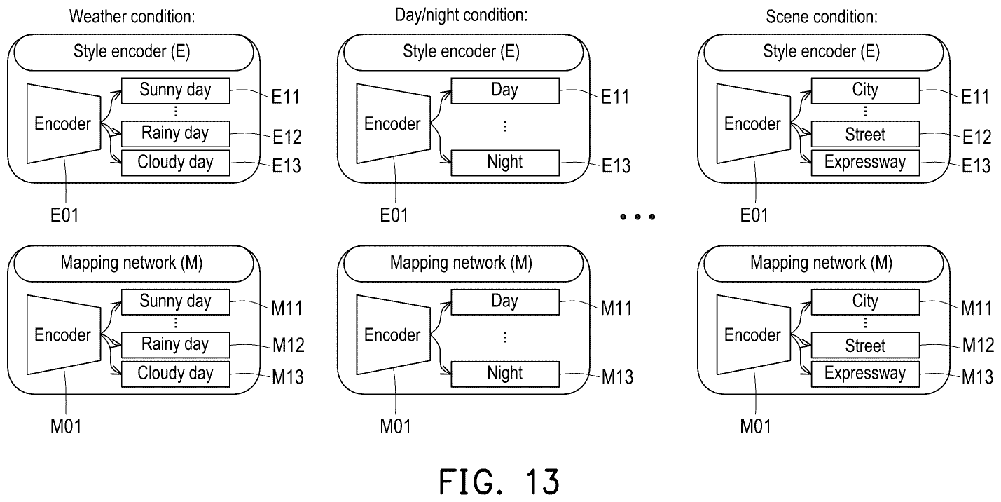

FIG. 13 is a schematic diagram of a style option according to an embodiment of the disclosure. Please refer to FIG. 13. Different style options may be customized according to different design requirements. Taking scenario simulation as an example, the style options of a weather condition are sunny day, rainy day, cloudy day, etc.; the style options of a day/night condition are day and night; and the style options of a scene condition are city, street, expressway, etc. The processor 120 may respectively train module pairs (that is, the style encoder E and the mapping network M corresponding to the same condition/type). The user may select the required condition/type according to requirements.

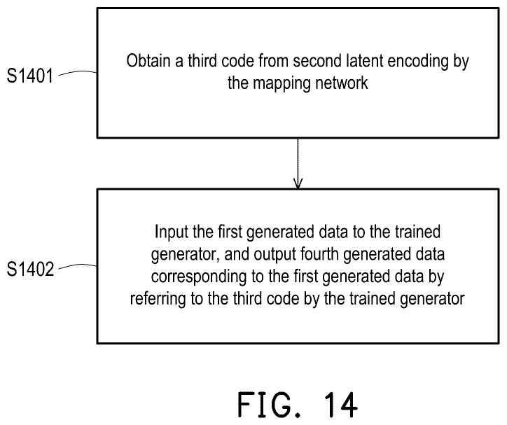

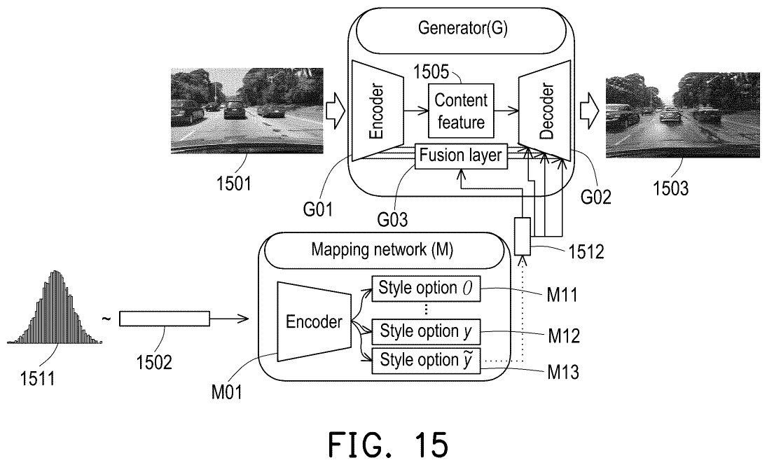

FIG. 14 is a flowchart of inference of multi-domain conditions related to a data generation framework according to an embodiment of the disclosure. Please refer to FIG. 14. The processor 120 obtains a third code from second latent encoding by the (trained) mapping network (step S1401). Specifically, the second latent encoding may be a value based on a statistical distribution such as a Gaussian distribution, a uniform distribution, or a Poisson distribution or data generated based on noise in a real environment. FIG. 15 is a schematic diagram of inference of multi-domain conditions related to a data generation framework according to an embodiment of the disclosure. Taking FIG. 15 as an example, the processor 120 obtains the first generated data or the third source data generated in step S530 of FIG. 5 from the storage 110. Reference may be made to the first source data 901 of FIG. 9 for the introduction of third source data 1501, which will not be repeated here.

In addition, the processor 120 samples a Gaussian distribution 1511, and generates second latent encoding 1502 according to sampled values. Next, the processor 120 takes the second latent encoding 1502 as the input of the trained mapping network M. That is, the second latent encoding 1502 is input to the trained mapping network M. Representations/performances learned by the encoder M01 of the mapping network M may capture common features between the tasks. The tasks correspond to, for example, different style options M11, M12, and M13. For example, the style option M11 numbered 0 is the cloudy day, the style option M12 numbered y is the sunny day, and the style options M13 numbered ŷ is the rainy day. The style option M13 numbered ŷ is one of the style option M11 numbered 0 to style options with other numbers. As mentioned above for the introduction of the second code, the second code generated by the mapping network M is a style code corresponding to a certain style option. Similarly, the third code generated by the mapping network M is a style code 1512 corresponding to a certain style option, such as corresponding to the style option M13 numbered ŷ.

Please refer to FIG. 14. The processor 120 inputs the first generated data or the third source data to the trained generator, and outputs fourth generated data corresponding to the first generated data or the third source data by referring to the third code by the trained generator (step S1402). Please refer to FIG. 15. The encoder G01 of the generator G retrieves a content feature 1505 from the first generated data or the third source data 1501. The fusion layer G03 fuses the feature data and the style code 1512 output by a certain encoder block (for example, the encoder block G11 of FIG. 11) of the encoder G01, and generates the fusion data. The processor 120 inputs the fusion data and the feature data (for example, the content feature 1505 or the output of other decoder blocks) to the corresponding decoder block of the decoder G02. Finally, the decoder G02 outputs fourth generated data 1503. The fourth generated data 1503 is data with the same content as the third source data 1501 or the first generated data and the style option corresponding to the style code 1502.

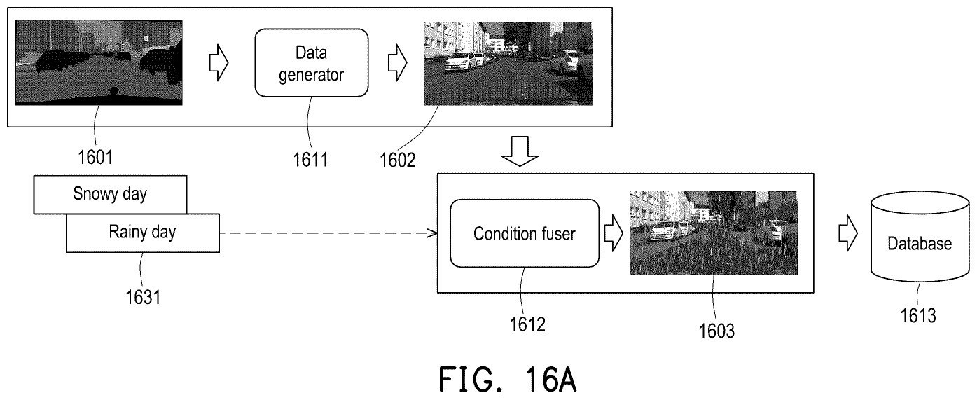

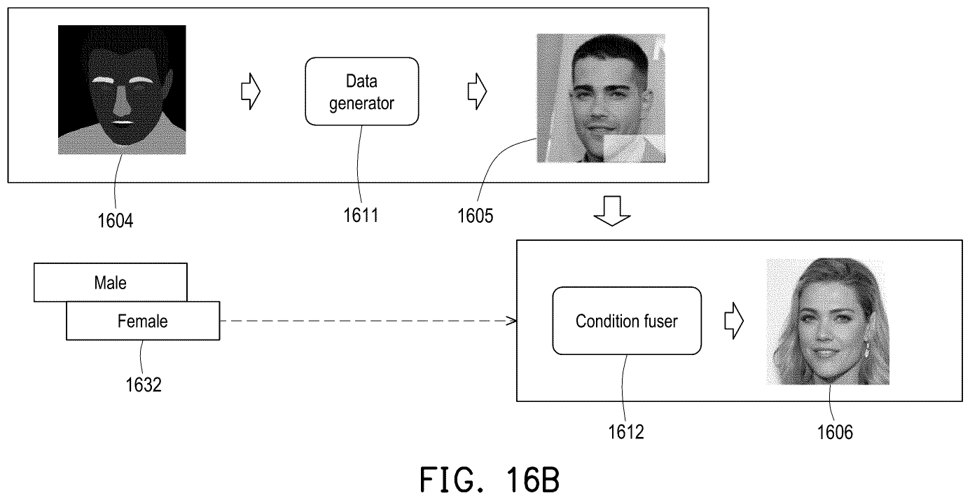

FIG. 16A is a schematic diagram of scene image generation according to an embodiment of the disclosure. Please refer to FIG. 16A. The embodiment of the disclosure provides a spatial conditioned pipeline and a multi-domain conditioned pipeline. For the application scenario of scene image generation (for example, a scene for self-driving car training), a simulator (for example, a car learning to act (CARLA) simulator or an annotated view sequence) may generate semantic mask data 1601. The semantic mask data 1601 defines semantic categories corresponding to multiple pixels of generated data 1602. For example, the pixels in a certain image region correspond to a lane, the pixels in another image region correspond to a vehicle, and the pixels in another image region correspond to the sky. It should be noted that the semantic mask data 1601 is not limited to defining two-dimensional data, but may also be used to define three-dimensional, four-dimensional, or more dimensional data. For example, a three-dimensional semantic mask is composed of three channels (that is, height, width, and number of categories), and a four-dimensional semantic mask further includes a time dimension compared to the three-dimensional semantic mask. A data generator 1611 (used to execute step S510 to step S530 of FIG. 5) may refer to the semantic mask data 1601 and output the predicted noise, generate the noise removed data according to the difference between the predicted noise and the noise data, and convert the noise removed data into the generated data 1602 by the decoder corresponding to the initial encoder. Multiple image regions in the generated data 1602 may correspond to the corresponding semantic categories defined by the semantic mask data 1601.

Next, a condition fuser 1612 (used to execute step S1401 and step S1402 of FIG. 14) obtains a style code corresponding to a style option 1631 (for example, a snowy day or a rainy day), and converts the input generated data 1602 into generated data 1603, such as a street picture of the rainy day, by the trained generator. The processor 120 may store the generated data 1603 in a database corresponding to the style option 1631. Multiple generated data 1603 may form a data set. The style option 1631 may be an input content corresponding to a user operation or may be generated based on specific conditions or random numbers and may be changed according to requirements of the user.

FIG. 16B is a schematic diagram of facial image generation according to an embodiment of the disclosure. Please refer to FIG. 16B. For the application scenario of facial image generation, semantic mask data 1604 may be obtained from the data set. The semantic mask data 1604 defines semantic categories corresponding to multiple pixels of the generated data 1605. For example, the pixels in a certain image region correspond to hair, the pixels in another image region correspond to a nose, and the pixels in another image region correspond to a mouth. Similarly, the data generator 1611 (used to execute step S510 to step S530 of FIG. 5) may refer to the semantic mask data 1604 and output the predicted noise, generate the noise removed data according to the difference between the predicted noise and the noise data, and convert the noise removed data into the generated data 1605 by the decoder corresponding to the initial encoder. Multiple image regions in the generated data 1605 may correspond to the corresponding semantic categories defined by the semantic mask data 1604.

Next, the condition fuser 1612 (used to execute step S1401 and step S1402 of FIG. 14) obtains a style code corresponding to a style option 1632 (for example, a male or a female), and converts the input generated data 1605 into generated data 1606, such as a facial picture of the female, by the trained generator.

It should be noted that the training data sets for the spatial conditioned pipeline and the multi-domain conditioned pipeline may be different, and the training stages of the two pipelines may be performed respectively.

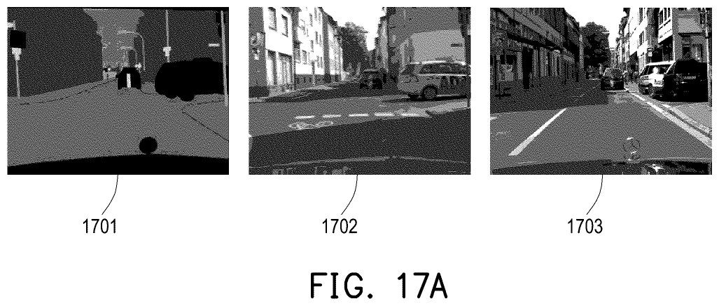

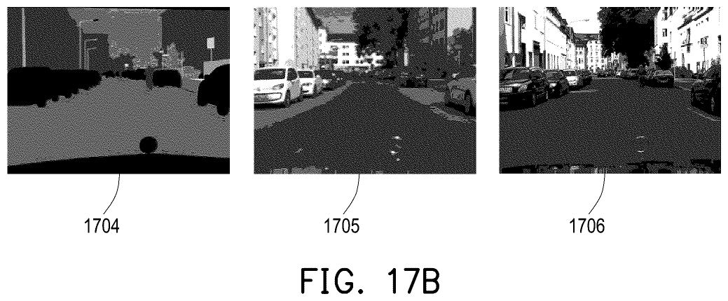

FIG. 17A and FIG. 17B are experimental results of a spatial conditioned pipeline according to an embodiment of the disclosure. Please refer to FIG. 17A. Generated data 1703 corresponding to a ground truth 1702 may be generated based on semantic mask data 1701. Multiple image regions in the generated data 1703 may correspond to corresponding semantic categories defined by the semantic mask data 1701. Please refer to FIG. 17B. Generated data 1706 corresponding to a ground truth 1705 may be generated based on semantic mask data 1704. Multiple image regions in the generated data 1706 may correspond to corresponding semantic categories defined by the semantic mask data 1704.

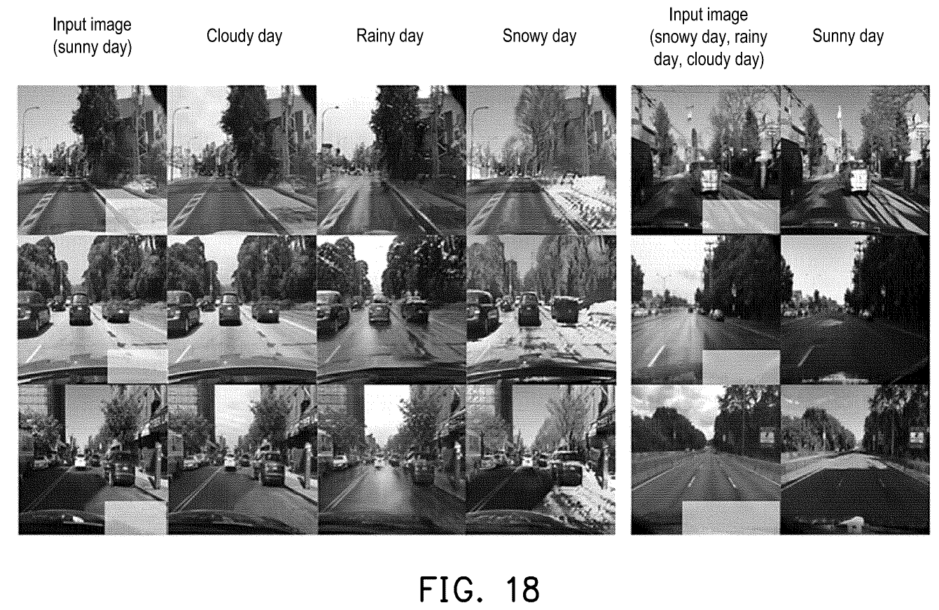

FIG. 18 is an experimental result of a multi-domain conditioned pipeline according to an embodiment of the disclosure. Please refer to FIG. 18. Assuming that an input image is a street picture of a sunny day, street pictures with style options of a cloudy day, a rainy day, and a snowy day may be generated respectively. Except for weather, image contents of the street pictures all correspond to the street picture of the input image. Alternatively, assuming that input images are respectively street pictures of the snowy day, the rainy day, and the cloudy day, the street pictures may be respectively transformed into the street picture of the sunny day, but the original street content is still retained.

In summary, in the method and the apparatus related to the data generation framework according to the embodiments of the disclosure, the prediction model for identifying/predicting the noise data is trained, and the corresponding noise removed data is converted into the generated data. In this way, the high-resolution data that is close to the real world may be generated. In addition, the style code corresponding to the style option is retrieved, the generator refers to the style code, and judges whether the output of the generator is real or fake through the discriminator. In this way, the trained generator may be used to generate the generated data that conforms to the specific style option, and the generated data may still retain the source content. The generated data may be evaluated on various data sets to verify the quality and the robustness of the data generation.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A method related to a data generation framework, implemented by a processor, the method comprising:
obtaining a latent representation from training data by an initial encoder;
combining the latent representation and first noise data to generate a noisy latent representation;
inputting the noisy latent representation to a prediction model, and outputting an initial prediction corresponding to the noisy latent representation by referring to first semantic mask data by the prediction model, wherein the first semantic mask data defines at least one first semantic category for the training data; and
updating the prediction model according to a prediction error between the initial prediction and the first noise data to generate a trained prediction model.

2. The method related to the data generation framework according to claim 1, wherein the prediction model comprises a first encoder and a first decoder, the first encoder is connected to the first decoder, the first encoder comprises at least one first encoder block, the first decoder comprises at least one first decoder block, and the step of outputting the initial prediction corresponding to the noisy latent representation by referring to the first semantic mask data by the prediction model comprises:
inputting the noisy latent representation to the first encoder;
inputting the first semantic mask data and feature data to one of the at least one first decoder block, wherein the feature data is an output of one of the at least one first encoder block or an output of another one of the at least one first decoder block; and
outputting the initial prediction by the first decoder.

3. The method related to the data generation framework according to claim 2, further comprising:
generating the first semantic mask data with a plurality of sizes, wherein the first semantic mask with one of the sizes is aligned to a size of feature data input to one of the at least one first decoder block, and the first semantic mask data and the feature data with a same size are input to one of the at least one first decoder block.

4. The method related to the data generation framework according to claim 1, wherein the prediction error is a sum of a first error and a second error, the initial prediction comprises a predicted mean and a predicted variation, and the step of updating the prediction model according to the prediction error between the initial prediction and the first noise data comprises:
calculating a difference between the predicted mean and a mean of the first noise data to determine the first error; and
calculating a difference between the predicted variation and a variation of the first noise data to determine the second error.

5. The method related to the data generation framework according to claim 1, further comprising:
inputting second noise data to the trained prediction model, and outputting predicted noise corresponding to the second noise data by referring to second semantic mask data by the trained prediction model, wherein the second semantic mask data defines at least one second semantic category for first generated data;
generating noise removed data according to a difference between the predicted noise and the second noise data; and
converting the noise removed data into the first generated data by a decoder corresponding to the initial encoder.

6. The method related to the data generation framework according to claim 5, further comprising:
inputting the noise removed data to the trained prediction model, and outputting the predicted noise corresponding to the noise removed data by referring to the second semantic mask data by the trained prediction model.

7. The method related to the data generation framework according to claim 5, further comprising:
obtaining a first code from reference data by a style encoder;
obtaining a second code from latent encoding by a mapping network, wherein the first code and the second code form a style code, and the style code corresponds to at least one style option;
inputting first source data to a generator, and outputting a first output corresponding to the first source data by referring to the style code by the generator; and
inputting the first output to a discriminator, and outputting a second output corresponding to the first output by the discriminator, wherein the second output comprises real or fake corresponding to the at least one style option.

8. The method related to the data generation framework according to claim 7, wherein the generator comprises a second encoder and a second decoder, the second encoder is connected to the second decoder, the second encoder comprises at least one second encoder block, the second decoder comprises at least one second decoder block, and the step of outputting the first output corresponding to the first source data by referring to the style code by the generator comprises:
fusing feature data output by one of the at least one second encoder block and the style code to generate fusion data; and
inputting the fusion data and another feature data to one of the at least one second decoder block, wherein the another feature data is an output of one of the at least one second encoder block or an output of another one of the at least one second decoder block.

9. The method related to the data generation framework according to claim 7, further comprising:
updating at least one of the style encoder, the mapping network, the generator, and the discriminator according to a style error, wherein the style error comprises a style similarity error, a source preservation error, and a content comparison error, and the step of updating the at least one of the style encoder, the mapping network, the generator, and the discriminator according to the style error comprises:
calculating a difference between the two first codes respectively obtained from the first source data and second source data by the style encoder to determine the style similarity error;
calculating a difference between the first source data and second generated data to determine the source preservation error, wherein the generator outputs third generated data corresponding to the first source data by referring to the style code, the generator outputs the second generated data corresponding to the third generated data by referring to a second style code, the second style code is obtained from second reference data by the style encoder, and the second reference data and the first source data correspond to a same one of the at least one style option; and
calculating a difference between a first feature representation and a second feature representation, and calculating a difference between the second feature representation and a third feature representation to determine the content comparison error, wherein the first feature representation is obtained from the first source data by a second encoder of the generator, the second feature representation is obtained from the third generated data by the second encoder, and the third feature representation is obtained from the reference data by the second encoder.

10. The method related to the data generation framework according to claim 7, further comprising:
obtaining a third code from second latent encoding by the mapping network; and
inputting the first generated data to the trained generator, and outputting fourth generated data corresponding to the first generated data by referring to the third code by the trained generator.

11. An apparatus related to a data generation framework, comprising:
a storage, used to store a program code; and
a processor, coupled to the storage and configured to load the program code to execute:
obtaining a latent representation from training data by an initial encoder;
combining the latent representation and first noise data to generate a noisy latent representation;
inputting the noisy latent representation to a prediction model, and outputting an initial prediction corresponding to the noisy latent representation by referring to first semantic mask data by the prediction model, wherein the first semantic mask data defines at least one first semantic category for the training data; and
updating the prediction model according to a prediction error between the initial prediction and the first noise data to generate a trained prediction model.

12. The apparatus related to the data generation framework according to claim 11, wherein the prediction model comprises a first encoder and a first decoder, the first encoder is connected to the first decoder, the first encoder comprises at least one first encoder block, the first decoder comprises at least one first decoder block, and the processor is further configured to:
input the noisy latent representation to the first encoder;
input the first semantic mask data and feature data to one of the at least one first decoder block, wherein the feature data is an output of one of the at least one first encoder block or an output of another one of the at least one first decoder block; and
output the initial prediction by the first decoder.

13. The apparatus related to the data generation framework according to claim 12, wherein the processor is further configured to:
generate the first semantic mask data with a plurality of sizes, wherein the first semantic mask with one of the sizes is aligned to a size of feature data input to one of the at least one first decoder block, and the first semantic mask data and the feature data with a same size are input to one of the at least one first decoder block.

14. The apparatus related to the data generation framework according to claim 11, wherein the prediction error is a sum of a first error and a second error, the initial prediction comprises a predicted mean and a predicted variation, and the processor is further configured to:
calculate a difference between the predicted mean and a mean of the first noise data to determine the first error; and
calculate a difference between the predicted variation and a variation of the first noise data to determine the second error.

15. The apparatus related to the data generation framework according to claim 11, wherein the processor is further configured to:
input second noise data to the trained prediction model, and output predicted noise corresponding to the second noise data by referring to second semantic mask data by the trained prediction model, wherein the second semantic mask data defines at least one second semantic category for first generated data;
generate noise removed data according to a difference between the predicted noise and the second noise data; and
convert the noise removed data into the first generated data by a decoder corresponding to the initial encoder.

16. The apparatus related to the data generation framework according to claim 15, wherein the processor is further configured to:
input the noise removed data to the trained prediction model, and output the predicted noise corresponding to the noise removed data by referring to the second semantic mask data by the trained prediction model.

17. The apparatus related to the data generation framework according to claim 15, wherein the processor is further configured to:
obtain a first code from reference data by a style encoder;
obtain a second code from latent encoding by a mapping network, wherein the first code and the second code form a style code, and the style code corresponds to at least one style option;
input first source data to a generator, and output a first output corresponding to the first source data by referring to the style code by the generator; and
input the first output to a discriminator, and output a second output corresponding to the first output by the discriminator, wherein the second output comprises real or fake corresponding to the at least one style option.

18. The apparatus related to the data generation framework according to claim 17, wherein the generator comprises a second encoder and a second decoder, the second encoder is connected to the second decoder, the second encoder comprises at least one second encoder block, the second decoder comprises at least one second decoder block, and the processor is further configured to:
fuse feature data output by one of the at least one second encoder block and the style code to generate fusion data; and
input the fusion data and another feature data to one of the at least one second decoder block, wherein the another feature data is an output of one of the at least one second encoder block or an output of another one of the at least one second decoder block.

19. The apparatus related to the data generation framework according to claim 17, wherein the processor is further configured to:
update at least one of the style encoder, the mapping network, the generator, and the discriminator according to a style error, wherein the style error comprises a style similarity error, a source preservation error, and a content comparison error, and the step of updating the at least one of the style encoder, the mapping network, the generator, and:
calculate a difference between the two first codes respectively obtained from the first source data and second source data by the style encoder to determine the style similarity error;
calculate a difference between the first source data and second generated data to determine the source preservation error, wherein the generator outputs third generated data corresponding to the first source data by referring to the style code, the generator outputs the second generated data corresponding to the third generated data by referring to a second style code, the second style code is obtained from second reference data by the style encoder, and the second reference data and the first source data correspond to a same one of the at least one style option; and
calculate a difference between a first feature representation and a second feature representation, and calculate a difference between the second feature representation and a third feature representation to determine the content comparison error, wherein the first feature representation is obtained from the first source data by a second encoder of the generator, the second feature representation is obtained from the third generated data by the second encoder, and the third feature representation is obtained from the reference data by the second encoder.

20. The apparatus related to the data generation framework according to claim 17, wherein the processor is further configured to:
obtain a third code from second latent encoding by the mapping network; and
input the first generated data to the trained generator, and output fourth generated data corresponding to the first generated data by referring to the third code by the trained generator.
